(19) United States
(12) Patent Application Publication
(10) Pub. No.: US 2007/0152881 A1
(43) Pub. Date: Jul. 5, 2007

(54) Multi-band antenna system

(76) Inventor: Yiu K. Chan, Vernon Hills, IL (US)

Correspondence Address: MOTOROLA INC, 600 NORTH US HIGHWAY 45, ROOM AS437, LIBERTYVILLE, IL, 60048-5343, US

(21) Appl. No.: 11/322,139

(22) Filed: Dec. 29, 2005

(51) Int. Cl. H01Q 1/38

(52) U.S. Cl. 343/700 MS; 343/702

(57) ABSTRACT

An antenna (100) is provided, which can be used in a wireless communication device or a base transceiver station forming part of the infrastructure of a wireless communication system. The antenna includes a first plate conductor (102) and a second plate conductor (104), which are substantially symmetric. The first plate conductor and the second plate conductor are separated by a central slot (106) and include respective primary feed points proximate the central slot, which are adapted for receiving a differential signal from a differential signal source (108). The first plate conductor and the second plate conductor exhibit at least a first frequency response (F1) and a second frequency response (F2) dependent on various dimensions of both the first plate conductor and the second plate conductor, relative to their respective primary feed point.

### FIELD OF THE INVENTION

This invention relates in general to antenna systems, and more specifically to a multi-band antenna, which includes at least a pair of substantially symmetric plate conductors, which radiates and receives signals dependent upon the dimensions of the plate conductors relative to the respective feed points.

### BACKGROUND OF THE INVENTION

In connection with wireless communication devices, such as cellular telephones, there is a trend toward smaller devices with increasing functionality. At least part of the trend with respect to increased functionality involves the device communicating wirelessly in support of an ever increasing number of wireless communication standards, each of which often involves a unique set of frequencies. In order to support a greater number of wireless communication types and/or standards, the circuitry within the device needs to potentially be able to support and effectively communicate over several different frequency bands.

At least one element that forms part of the communication circuitry, which supports wireless communication includes an antenna. An antenna is a device for radiating and receiving electromagnetic waves. In at least some instances, some earlier devices would support multiple frequency bands through the use of separate dedicated circuitry, each corresponding to a different set of the multiple frequency bands, and each with its own space requirements within the device. However, allocating space for a proliferation of separate dedicated circuitry has become increasingly difficult, in those instances where overall device size has similarly decreased.

Phone developers have increasingly explored the possibilities of circuitry, which supports multiple frequency bands. For example, a multi-band antenna is an antenna, that can be used in more than one frequency band, which may be needed for more fully supporting the desired different types of wireless communication standards. Examples of different wireless standards, which often involve communication signals operating in different frequency bands, include at least a couple of personal cellular communication standards, such as Global System for Mobile Communications (GSM) and Code Division Multiple Access (CDMA), several wireless local area network standards, such as Wireless Fidelity (WIFI) or (WLAN) and Bluetooth, as well as several support communication services, such as Global Positioning Systems (GPS). For a wireless communication device to be reasonably efficiently operational in multiple bands, various combinations of antenna systems of the wireless communication device are frequently implemented to provide suitable coverage at the frequencies of interest.

As noted previously, a wireless communication device operational in multiple bands has historically, frequently included multiple antenna systems adapted for resonating at different frequencies. However, including multiple antenna systems in a wireless communication device may minimize the volume available for including other functional components, and/or may impact the overall size of the device. In the case of network elements, such as a base transceiver station (BTS), which supports the transmission and reception of wireless communication signals between the network infrastructure and wireless communication devices, operation in different frequency bands can sometimes involve the use of multiple antennas. Each antenna included in the BTS increases not only the initial costs incurred as part of the original deployment, but also affects ongoing maintenance costs.

Existing multi-band antenna systems, which resonate at multiple frequencies, often involve their resonating frequencies being dependent upon the various dimensions of one or more conductors, which function as the antenna. Hence, the frequencies of resonation are largely influenced by the shape of the multi-band antenna. Presently, designers of mobile communication device are constrained in the design of mobile devices, due to the number and size of the requisite antennas, and the respective space requirements of the corresponding elements to be included within the device.

Still further to the extent that an antenna can be incorporated as part of any existing structure of other elements, and still support the desired multiple frequency bands of interest, without materially impacting in a negative way the other elements functional purpose, it would serve to further beneficially impact space concerns and/or constraints. In support of the same, the present inventor has developed a multi-band antenna structure, which can be more readily incorporated as part of the exiting phone structure, such as the housing or chassis structure of the device.

### SUMMARY OF THE INVENTION

The present invention provides an antenna, which includes first and second plate conductors, which are substantially symmetric. The dimensions of each plate conductor include a respective length and width, where the first and second plate conductors are separated by a central slot having a predetermined width. Each of the first and second plate conductors includes a respective primary feed point proximate the central slot, which together are adapted for receiving a differential signal. The first and second plate conductors are adapted for radiating one or more signals at two or more frequencies, where the two or more frequencies are dependent upon one or more of the dimensions of the first and second plate conductors in relation to the respective feed point.

In at least one embodiment, the antenna includes a notch, at the edge of the plate conductor opposite the primary feed point, which extends in from the edge of the plate conductor, proximate the central slot. The notch extends in from the edge a distance corresponding to a depth of the notch, wherein the effective width of the respective plate conductor is dependant upon the distance between the primary feed point and the opposite edge, less the depth of the notch.

In at least a further embodiment one or more of the respective plate conductors of the antenna includes a secondary slot, which extends from a distal one of a pair of edges defined by the length of the plate conductor, which is distal relative to the central slot. The slot extends from the distal edge and extends along a path toward a center of the respective conductor along the length of the plate conductor, and wherein the secondary slot includes a respective secondary feed point proximate the end of the secondary slot toward the center of the respective plate conductor, and wherein the respective plate conductor is adapted to radiate at a third frequency, where the third frequency is dependent upon the length of the path of the secondary slot relative to the secondary feed point.

The present invention further provides for a wireless communication device, which incorporates the antenna.

The present invention still further provides for a base transceiver station forming part of an infrastructure of a wireless communication system, which incorporates the antenna.

These and other objects, features, and advantages of this invention are evident from the following description of one or more preferred embodiments of this invention, with reference to the accompanying drawings.

### BRIEF DESCRIPTION OF THE DRAWINGS

The present invention is illustrated by way of example, and not limitation, in the accompanying figures, in which like references indicate similar elements, and in which:

FIG. 1 is a plan view of an antenna system, in accordance with a first exemplary embodiment;

FIG. 2 is a plan view of an antenna system, in accordance with a second exemplary embodiment;

FIG. 3 is a plan view of an antenna system, in accordance with a third exemplary embodiment;

FIG. 4 is a plan view of an antenna system, in accordance with a fourth exemplary embodiment;

FIG. 5 is a plan view of an antenna system, in accordance with a fifth exemplary embodiment;

FIG. 6 is a plan view of an antenna system, in accordance with a sixth exemplary embodiment;

FIG. 7 is a plan view of an antenna system, in accordance with a seventh exemplary embodiment;

FIG. 8 is a plan view of an antenna system, in accordance with an eighth exemplary embodiment; and

FIG. 9 is a return loss plot of an antenna system, in accordance with an exemplary embodiment.

Skilled artisans will appreciate that elements in the figures are illustrated for simplicity and clarity, and have not necessarily been drawn to scale. For example, the dimensions of some of the elements in the figures may be exaggerated relative to other elements to help to improve understanding of the embodiments shown.

### DETAILED DESCRIPTION

Before describing in detail the particular multi-band antenna system embodiments, it should be observed the antenna components have been represented where appropriate by conventional symbols in the drawings, showing only those specific details that are pertinent to-understanding the present invention so as not to obscure the disclosure with details that will be readily apparent to those of ordinary skill in the art, which have the benefit of the teachings disclosed herein.

In this document, relational terms such as first and second, and the like, may be used solely to distinguish one entity or action from another entity or action without necessarily requiring or implying any actual such relationship or order between such entities or actions. The terms “comprises”, ”comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including” and/or “having”, as used herein, are defined as comprising. The term “coupled”, as used herein with reference to electrical technology, is defined as connected, although not necessarily directly, and not necessarily mechanically.

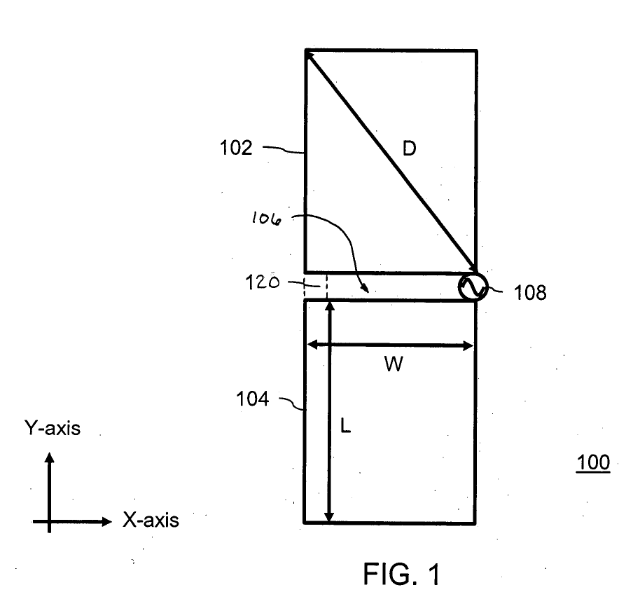

FIG. 1 is a plan view of an antenna system 100, in accordance with a first exemplary embodiment. The terms antenna system and antenna refer to the same element and are hence used interchangeably. The antenna 100 is used for transmitting and receiving electromagnetic signals in a wireless communication network. The antenna 100 can be implemented as an internal antenna embedded within a wireless communication device, such as a mobile phone. In another embodiment, the antenna 100 can be implemented as an antenna arranged with equipment forming part of the cellular infrastructure, which supports communication with the wireless communications device, such as a base transceiver station (BTS). The antenna 100 comprises a first plate conductor 102 and a second plate conductor 104. A plate conductor, as used herein, corresponds to a conductor having a meaningful dimension in more than one dimension, generally referred to as length and width. A measurement in a third dimension, corresponding to a depth of the plate conductor, may or may relatively negligible, but does not necessarily need to be, and for purposes of the present invention is generally inconsequential, but may serve to define a further conductive surface. In at least some embodiments, the first plate conductor 102 and the second plate conductor 104 are substantially symmetric.

Both the first plate conductor 102 and the second plate conductor 104, in the illustrated embodiment are rectangular plates, which have a width W and a length L (as shown in FIG. 1), as well as a corresponding length D in a diagonal direction. In the FIG. 1, the length (L) of the rectangular plates is along a Y-axis, while the width (W) is along an X-axis. Hence, both the first plate conductor 102 and the second plate conductor 104 have two opposite edges that are L units long and two opposite edges that are W units long along the width of the respective plate conductor. However, while the overall shape of the first and second plate conductors are generally symmetric, each plate conductor can have features, which may not be replicated in the other.

The antenna 100 further comprises a central slot 106, which separates the first plate conductor 102 from the second plate conductor 104. In one embodiment of the invention, the central slot 106 separates respective adjacent edges of each of the plate conductors, which extends the width of the conductors, in a direction along the X-axis. In another embodiment of the invention, the central slot 106 could alternatively extend along the Y-axis, in which case the first and second plate conductors would be positioned side by side, as opposed to end-to-end. However, with respect to the illustrated embodiment, while traversing a path from the first plate conductor 102 to the second metallic plate 104 along each of their respective lengths, the central slot 102 serves as a discontinuity in the conductive paths. The distance between the respective edges of the first and second plate conductors, defines a width of the slot. In at least one embodiment of the present invention, the discontinuity which serves to define the central slot 106 can be filled in by a dielectric. In at least some embodiments of the present invention, the space is filled with air, which has a corresponding dielectric constant.

Each of the respective conductive plates, includes a primary feed point proximate the central slot, which together are adapted for receiving a differential signal produced by a signal source 108. The primary feed points are positioned proximate the central slot 106, which is located between the first plate conductor 102 and the second plate conductor 104. Where the primary feed points are positioned at the mid point of the central slot 106 relative to the width of the respective conductive plates, the antenna 100 in at least one dimension corresponding to the width of the conductive plates, would acts as a series feed dipole. In another embodiment of the invention, the differential feed points are positioned at one end of the central slot 106, corresponding to one of the two edges defined by the width of the conductive plate, as shown in FIG. 1. This is sometimes referred to as an eccentric feed. In such an instance, the antenna 100 acts as a series feed magnetic monopole in at least a corresponding one of the dimensions including the width, and an electric dipole response in at least another corresponding one of the dimensions including the diagonal length, each of which corresponds to a respective fundamental frequency response of the respective conductive plates. The at least two fundamental frequency responses exhibited by the antenna 100 include a first frequency response (F1) corresponding to the first dimension associated with the diagonal length D of each of the first and second plate conductors, and a second frequency response (F2) corresponding to a second dimension associated with the effective width W of the first and second plate conductors.

Generally, in accordance with at least one embodiment, the first frequency response (F1) is inversely proportional to the diagonal length (D). In other words, decreasing the length of the diagonal (D) will increase the corresponding resonant frequency (F1), while alternatively increasing the length of the diagonal (D) will decrease the corresponding resonant frequency (F1). The first frequency response (F1) of the antenna 100 can be referred to as an electric dipole response of the antenna 100.

Generally, in accordance with at least one embodiment, the second frequency response (F2) is inversely proportional to the width (W). In other words, decreasing the width (W) will increase the corresponding resonant frequency (F2), while alternatively increasing the width (W) will decrease the corresponding resonant frequency (F2). The second frequency response (F2) is effectively independent of the length (L) of both the first plate conductor 102 and the second plate conductor 104. The second frequency response (F2) of the antenna 100 can be referred to as a magnetic monopole response of the antenna 100.

Exemplary values of the first frequency response (F1) and the second frequency response (F2) are 800 MHz and 1800 MHz, respectively.

Alternatively, the first and second plate conductors could include a conductive bridge at the edge opposite of the position of the primary feed points, in which case the two conductive plates, together, would act to form a shunt feed magnetic monopole. In such an instance, the feed impedance to the shunt feed magnetic monopole will be meaningfully higher than 50 ohms. Instead, an impedance on the order of 1000 ohms to as high as on the order of 10000 ohms will be presented. For more optimal energy conduction, the signal source/load impedance to this feed should be close to and the conjugate of the feed impedance.

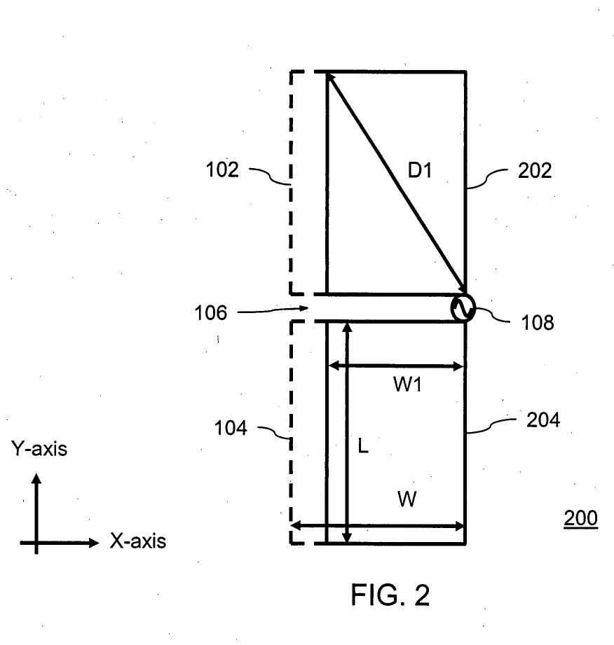

FIG. 2 is a plan view of an antenna system 200 in accordance with a second exemplary embodiment. The antenna 200 (as shown in FIG. 2) is similar to the antenna 100 as described in conjunction with FIG. 1. However, the dimensions of the antenna 200 are modified with relative to the dimensions of the antenna 100. The antenna 200 is shown with a first plate conductor 202 and a second plate conductor 204, which are substantially symmetric. The length (L) of the first and second plate conductors 202 and 204 are generally equivalent to the length (L) of the first plate conductor 102, whereas the width (W1) of the first and second plate conductors 202 and 204 are less than the width (W) of the first plate conductor 102 (the original width being associated with the plate conductors as illustrated in FIG. 1, are represented in FIG. 2 by dashed lines). The central slot 106 separates the first plate conductor 202 and the second plate conductor 204 in a similar manner that the central slot 106 separates the first plate conductor 102 and the second plate conductor 104 (shown in FIG. 1). Each of the conductive plates, similarly includes a respective primary feed point proximate the central slot, which together are adapted for receiving a differential signal produced by the signal source 108.

The antenna 200 is substantially equivalent to the antenna 100, except for the modified dimensions of the first metallic plate 202 and the second metallic plate 204. Hence, the antenna 200 responds as the antenna 100 and acts as a series fed an electronic dipole and a magnetic monopole relative to respective ones of the two fundamental frequency responses. Both the first plate conductor 202 and the second plate conductor 204 resonate relatively efficiently in each of the two fundamental frequency responses. The two metallic plates also will resonate in at least some of the harmonics associated with the two fundamental frequency responses. However, out of the two frequency responses exhibited by the antenna 200, only one frequency response is different from the two frequency responses (F1 and F2) exhibited by the antenna 100. In other words, only a second frequency response (F2a) of the antenna 200 is different from the second frequency response (F2) of the antenna 100. The first frequency response (F1) of the antenna 200 is substantially the same as the first frequency response (F1) of the antenna 100. While the difference in width directly affects the corresponding dimension associated with the second frequency. A change in width has a less dramatic effect on the corresponding diagonal length, in part due to the unchanged length (L), being meaningfully larger than the width (W1). As a result, the value of the diagonal (D1) of the first plate conductor 202 and the second plate conductor 204 will be approximately the equal to the value of the (D) of the first plate conductor 102 and the second plate conductor 104 (shown in FIG. 1). The diagonal is the corresponding dimension, which affects the resulting first frequency.

As modified, the exemplary values of the first frequency response (F1) and the second frequency response (F2a) are approximately 800 MHz and 1900 MHz. Hence, it can be observed that the value of the second frequency response (F2) of antenna 100 may be changed from 1800 MHz to 1900 MHz by changing the width of both the metallic plates from W to W1, without materially affecting the first resonant frequency.

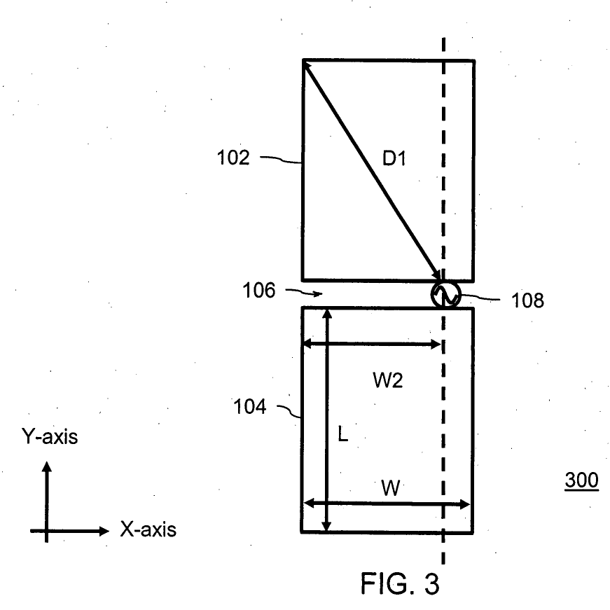

FIG. 3 is a plan view of an antenna system 300, in accordance with a third exemplary embodiment, and represents an alternative manner in which the effective width can be modified, without affecting the overall dimension of the first and second plate conductors. In at least some embodiments, the plate conductors may be incorporated as part of other elements, such as a printed circuit substrate, for which it may not be conveniently possible to introduce dimensional changes without negatively impacting the other functional aspects of the element, within which the antenna is incorporated. Conversely, the embodied teachings, could provide a means by which the dimensions of the plate conductors can be changed, while not materially affecting the corresponding frequency resonance.

Referring more particularly to the drawings, the antenna 300 (as shown in FIG. 3) is similar to the antenna 100 as described in conjunction with FIG. 1. However, the position of the primary feed points of the antenna 100, which are adapted for receiving a differential signal shown in FIG. 3 has been positioned a distance away from the edge.

Antenna 300 similarly includes a first metallic plate 102 and a second metallic plate 104 having a width of W units and a length of L units. The antenna 300 has the central slot 106 similar to the antenna 100. However, as noted above, the positioning of the differential feed points in the antenna 300 are positioned at an offset from the end of the central slot 106. In other words, the differential feed 108 is moved along the X-axis towards the mid point of the central slot 106.

The change in the position of the differential feed 108 from the edge of the central slot 106 causes the effective width of the first metallic plate 102 and the second metallic plate 104 to change from the initial value of width W to an effective width W2 (as shown in FIG. 3). The length (L) of the first metallic plate 102 and the second metallic plate 104 is not altered by the displacement of the differential feed 108. The width of the first metallic plate 102 and the second metallic plate 104 also remain unaltered at W units, by the displacement of the differential feed 108. However, the effective width W2 of the first metallic plate 102 and the second metallic plate 104 is less than the width W. In one embodiment, the effective width W2 is equal to the difference between the physical width (W) and the amount of the displacement of the differential feed points along the X-axis away from the end of the central slot 106. The effective width (W2) is the width, which is responsible for variations in frequency responses (dependent on W2) exhibited by the antenna 300. As the length (L) is significantly larger than the width (W2), the value of the diagonal (D1) will continue to be approximately equal to the value of the diagonal (D) of the first and second plate conductor 102 and 104 (shown in FIG. 1). The first resonant frequency of the antenna 300 (F1) dependent upon the diagonal length is substantially equal to the first resonant frequency of the antenna 100 (F1). The second frequency response (F2b) being dependent on the effective width (W2) will have changed by an amount dependent upon the above noted displacement.

Hence, by changing the position of the differential feed points, the width of the effective width used to determine the corresponding resonant frequency changes from W to W2. Consequently, antenna 300 has a second frequency response (F2b), which differs from the second frequency response (F2) of antenna 100. Exemplary values of the first frequency response (F1) and the second frequency response (F2b) for antenna 300 are 800 MHz and 1900 MHz, respectively. Hence, tuning of the antenna to the desired resonant frequencies is partially possible while retaining a degree of flexibility relative to the dimensioning of the plate conductors, i.e. without necessarily changing the overall dimensions of the plate conductors, where it may be desirable to allow the width to deviate from the effective width that coincides with the desired frequency of resonance for purposes of accommodating other design consideration.

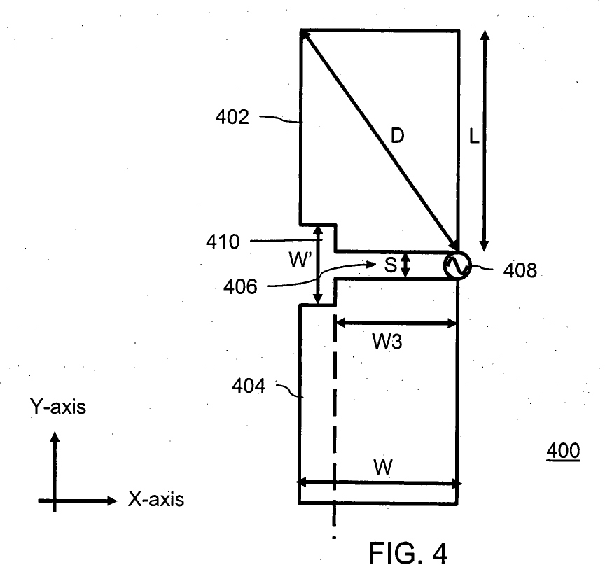

FIG. 4 is a plan view of an antenna system 400, in accordance with a fourth exemplary embodiment, and represents a further alternative manner in which the effective width can be modified, without affecting the overall dimension of the first and second plate conductors. More specifically, a notch is formed in each of the first and second plate conductors, with the notch being located in the side of the respective plate conductor, which is proximate the end of the central slot, which is opposite the end that the differential feed points are situated.

The antenna 400 (as shown in FIG. 4) is similar to the antenna 100 as described in conjunction with FIG. 1. As noted above, the antenna 400 additionally includes a notch 410 in addition to the components described in association with antenna 100. In the illustrated embodiment, the differential feed 408 is positioned at an end of the central slot 406. The notch 410 is produced by partially eliminating the requisite amount of material at the corresponding corners of the two plate conductors 402 and 404.

While generally, the notches will each have a depth, which extends in from the end of the central a distance corresponding to the desired change for the effective width. In at least one embodiment, the notch will extend from the edge of the plate conductor adjacent the central slot a distance along the length of each of the plate conductors, which has a width, which is approximately equal to the original width of the central slot. One skilled in the art will readily appreciate that deviations can be made in any of the dimensions, while still enjoying at least partial benefit of the present invention. For example, the notch width could be greater than the original width of the central slot, and still function as intended. In fact, the embodiment illustrated in FIG. 2 could be viewed as the case where the width of the notch extends the full length of the plate conductor. Furthermore, while the plate conductors are substantially symmetrical, the present invention can tolerate a degree of variation in many of the dimensions, relative to one or both of the plate conductors, while still substantially enjoying the benefits of the present invention.

Generally, the notch 410 is concentric along the X-axis of the central slot 406. The notch 410 is located at an end of the central slot opposite to the end where the differential feed points are positioned. The notch 410 produces a change in the length of the path in which a standing wave can form in the central slot 406. This allows for a frequency response of an antenna containing a notch, which is different from the frequency response of an antenna without the notch. Suitable dimensions for the notch 410 in some instances are dependent upon other dimensions of the antenna 400. In one embodiment, the width of the notch (M), which encompasses both plate conductors and the central slot (measured along the length L of the first metallic plate 402) is at least substantially equal to three times the width S of the central slot 406. The inclusion of notch 410 changes the effective width of both the first plate conductor 402 and the second plate conductor 404. The first plate conductor 402 and the second plate conductor 404 have an effective width (W3) each, which is equal to the difference between the width (W) and the depth of the notch 410 (measured along the width W of the first plate conductor 402 and the second plate conductor 404).

It is further possible that the shape of the notch, could be a shape other than square or rectangular. For example, the notch shape may be rounded or tapered, or even exponentially curved.

With the change in the effective width, the resonant frequencies, as determined by the disclosed relationships can be modified and determined in a manner similar to the previous embodiments, where a change in the effective width will have maximal effect upon the frequency primarily impacted by the effective width of the plate conductors, while having a diminished or more marginal effect relative to the resonant frequency, which is governed by the resulting diagonal length.

At least one embodiment of the present invention, which is consistent with the antenna structure described in conjunction with FIG. 4 supports a frequency bandwidth of up to 1.34 GHz at a span-factor of one hundred percent. The particular band of interest is tunable by manipulating the dimensions of the notch 410.

One skilled in the art will readily appreciate that it is further possible to incorporate an offset in the differential feed points, in addition to incorporating a notch as described above for affecting the resulting equivalent width.

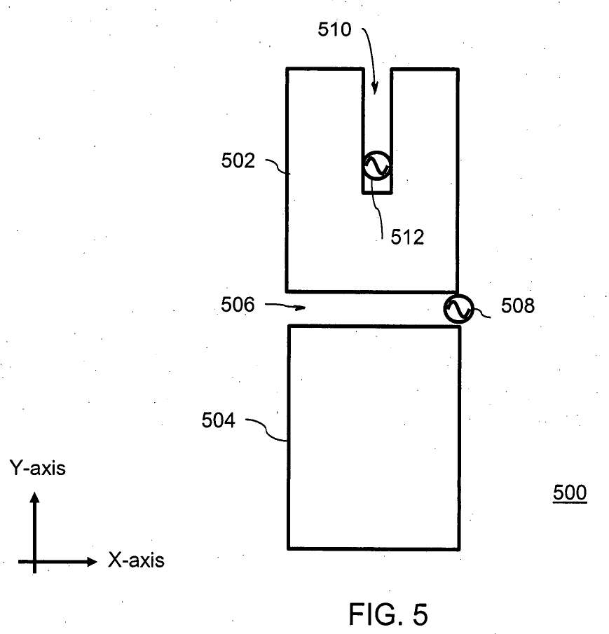

FIG. 5 is a plan view of an antenna system 500, in accordance with a fifth exemplary embodiment. The antenna 500 (as shown in FIG. 5) is similar to the antenna 100 as described in conjunction with FIG. 1. In addition to the basic structure described above in connection with the other embodiments, antenna 500 includes an additional slot added in at least one of the first and second plate conductors. In the illustrated embodiment, an additional slot is added to the first plate conductor 502. More specifically, the first plate conductor 502 includes a second slot 510, which begins at the edge of the first plate conductor distal relative to the central slot 506, and extends along the length of the first plate conductor 502, at least partially toward the central slot 506. In the illustrated embodiment, the second slot 510 has one end proximate the midpoint of the width (W) of the first plate conductor 502 relative to the X-axis. However, in various other embodiments of the invention, the second slot 510 is placed at various positions along the X-axis. Placement of the source of the second slot 510 proximate the midpoint of the width (W) of the first plate conductor, in some instances may provide for more optimal isolation relative to any co-located sources. In other words, because of the signal supplied at the differential feed point proximate the central slot 506 may have a common mode impact at the feed point for the second slot 510, by electrically balancing the two branches formed in the plate conductor 502 by the second slot 510, the signal supplied at the differential feed point when it arrives at the feed point of the second slot 510 is substantially in phase resulting in a common mode and corresponding having minimal or no effect relative to the resonant structure associated with the second slot 510.

In the illustrated embodiment, the second slot 510 is open at one end while it is closed at the other end. In other words, the second slot 510 is open at an edge of the first plate conductor 502 opposite to the edge along the central slot 506. Further, the second slot 510 is closed at an end of the slot, in a direction along the length of the plate conductor that is closer to the edge adjacent the central slot 506. In one embodiment of the invention, the length of the second slot 510 is less than or equal to three quarters of the length (L) of the first metallic plate 502.

The second slot 510 is provided with a second set of feed points, which are driven by a signal generator 512. By controlling the position of the second set of feed points relative to the closed end of the slot, the impedance of the antenna as seen by the signal generator can be adjusted, which allows for the two to have an at least partially managed relationship. Because the second slot 510 is closed at one end, the slot in conjunction with the second set of feed points represents a shunt feed. Closer to their extremes, the impedance of the resonant structure at the open end of the second slot 510 is of the order of 10000 ohm, whereas the impedance at the closed end of the second slot 510 is of the order of 10 ohm. In at least one embodiment, the second set of feed points is positioned to provide an impedance match having an exemplary impedance value of approximately 50 ohm. In this case, the position of the second set of feed points is chosen so as to enhance energy conduction between the signal source and the second set of feed points and the corresponding resonant structure, taking into account the disparity in the impedance values of the open end and the closed end of the second slot 510. As a result, the second set of feed points being fed by a 50 ohm source is placed proximate the closed end of the second slot 510.

By adding the second slot, and additional supporting structure, a further resonant frequency can be established, as part of the overall structure. The third frequency response (F3) is inversely proportional to the length of the second slot 510. In other words decreasing the length of the second slot 510 will increase the third frequency response (F3) and similarly, increasing the length of the second slot 510 will decrease the third frequency response (F3). The third frequency response (F3) is orthogonal to both the first frequency response (F1) and the second frequency response (F2). In other words the third frequency response (F3) propagates in a plane perpendicular (at 90 degrees) to both the plane of propagation of the first frequency response (F1) and the plane of propagation of the second frequency response (F2). Hence, the third frequency response (F3) does not interfere or overlap with the first frequency response (F1) and the second frequency response (F2). The third frequency response of the antenna 500 can be termed as the shunt feed magnetic monopole response of the antenna 500. Exemplary values of the first frequency response (F1), the second frequency response (F2) and the third frequency (F3) response are 800 MHz, 1800 MHz and 2100 MHz respectively.

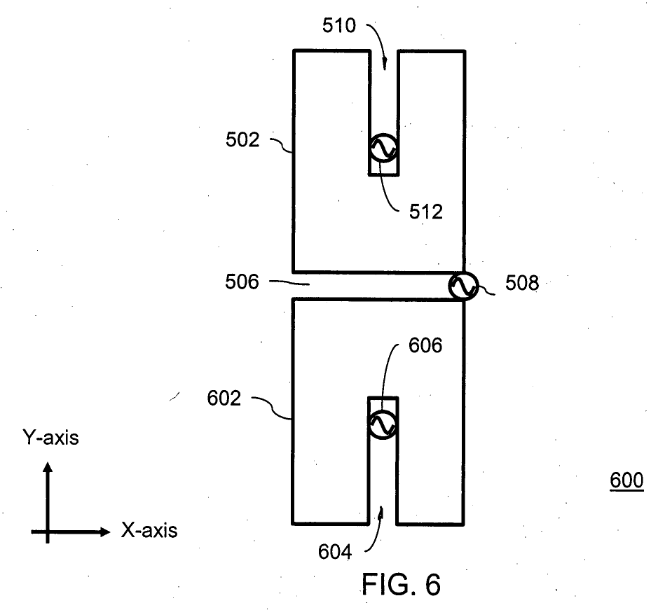

FIG. 6 is a plan view of an antenna system 600, in accordance with a sixth exemplary embodiment. The antenna 600 (as shown in FIG. 6) is similar to the antenna 500 as described in conjunction with FIG. 5. However, the antenna 600 includes a still further additional slot, which is formed as part of the second plate conductor, in addition to the components described in the antenna 500, which is capable of establishing a still further resonant structure, which can be separately tuned to a desired frequency. The same principles noted above in connection with the second slot, discussed in connection with FIG. 5, would similarly apply.

In at least one embodiment of the present invention, the second slot 510 and the third slot 604 could be of different lengths, thereby resulting in a frequency response with respect to each of the second and third slots, which are different. Alternatively, they could be of similar length, and operate as co-located independent radiators, which might be suitable for use in connection with UMTS diversity reception. In diversity reception, it is generally desirable to have approximately 15 dB of isolation between the antennas. The co-located independent radiators of antenna 600 can support approximately 17 to 21 dB of isolation. Independent radiators can also alleviate the burden of supporting a common feed architecture, where a common feed architecture might bundle all of the signals via one radio frequency (RF) port via a post switch-matrix network.

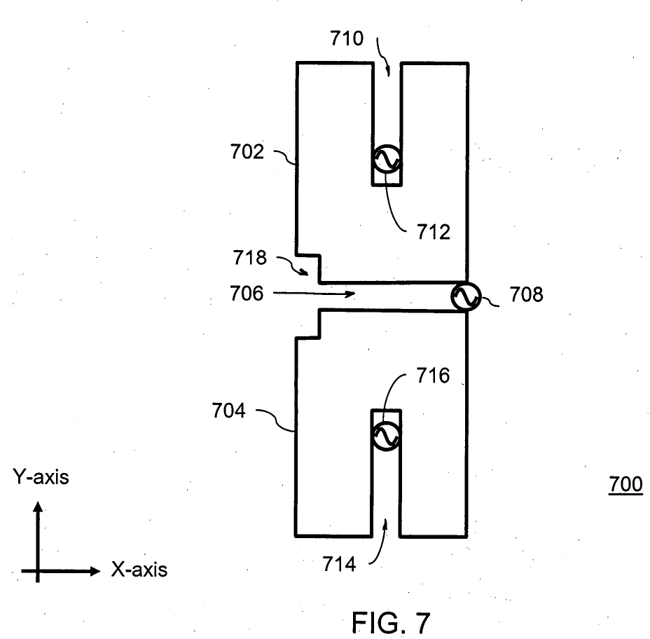

FIG. 7 is a plan view of an antenna system 700, in accordance with a seventh exemplary embodiment. The antenna 700 is substantially the same as the antenna illustrated in connection with FIG. 6, where a notch consistent with the embodiment illustrated in FIG. 4 has been added relative to the central slot for purposes of tuning the resonant frequency associated with the effective width of the first and second plate conductors 702 and 704. This in turn serves to highlight, that the techniques associated with modifying the effective width of the first and second plate conductors, described in connection with FIGS. 2-4, are similarly valid in conjunction with structures including additional resonant slot structures, as provided in FIGS. 5-8.

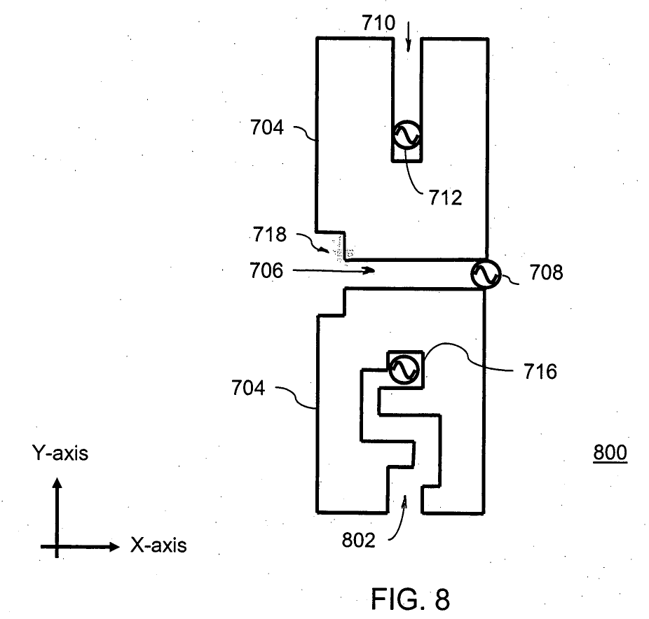

FIG. 8 is a plan view of an antenna system 800, in accordance with an eighth exemplary embodiment. The antenna 800 is substantially similar to the antenna 700 with the exception that the third slot 802 is allowed to change direction, which can sometimes be referred to as an indefinite meandering slot. In other words the third slot 802 has a variable number of bends along its length. By allowing the slot to meander an even longer slot length is possible, which in turn allows for a structure having a lower resonant frequency. In at least some embodiments, slot 802 can be tuned to approximately 1575 MHz, in support of a receiver for a global positioning system.

In one embodiment of the invention, the first frequency response (F1) and the second frequency response (F2c) are used for the reception and transmission of frequency bands between 800 MHz and 2100 MHz. These can be used to support various wireless communication protocols including Advanced Mobile Phone System (AMPS) (800 MHz-900 MHz) and Global System for Mobile Communications (GSM) (900 MHz and 1800 MHz) bands. The first frequency response (F1) and the second frequency response (F2c) can also be used for the transmission of Wideband Code Divisional Multiple Access (WCDMA) (1920 MHz-2170 MHz). In the illustrated embodiment, the third frequency response (F3) and the fourth frequency response (F4a) could alternatively be used for the transmission and reception of the WCDMA signals. More specifically, the frequency response (F3) of the second slot structure 710 could be used for the transmission and reception of the WCDMA signals, while the frequency response (F4a) associated with the meandering slot is used for the transmission and reception of Global Positioning System (GPS) and Wireless Local Area Network (WLAN) signals.

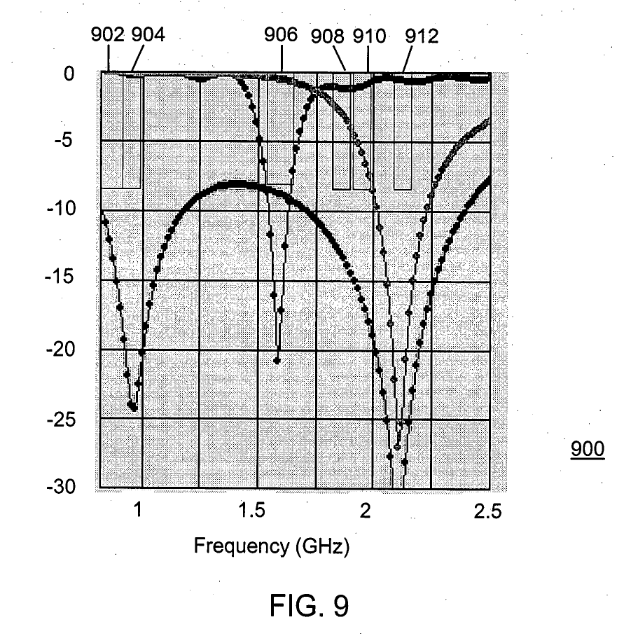

FIG. 9 is a return loss plot 900 for the antenna system 800 as shown in FIG. 8. The return loss plot 900 exhibits six bands of operation 902, 904, 906, 908, 910 and 912, which are respectively centered at approximately 800 MHz, 900 MHz, 1570 MHz, 1800 MHz, 1900 MHz and 2170 MHz. Thus, the antenna system 800 shown in FIG. 8 is able to support communications in a plurality of frequency bands.

As noted previously, the antenna in various embodiments can be used for the transmission and reception of as a radiation component in wireless communication devices as well as the infrastructure, which supports a wireless communication system, when it is fed by a balanced transmission line. The antenna can also act as a broadband directive and/or as a reflective element as in a Yagi antenna or other similar antenna. The antenna can also act as an element in a “corner reflector” antenna or as part of an antenna array system. In at least some embodiments, the antenna can also be serve as a substrate, as part of a printed circuit board for the placement of electronic components which support other aspects of a wireless communication devices, as long as all integrated components and printed wires are properly RF shielded. Additionally, other parts such as Liquid Crystal Display (LCD), digital imagers, batteries, flex cables, printed signal lines, floating metals and other high dielectric materials present in the wireless communication device should also be shielded. The two metallic plates that form the chassis are RF isolated from one another and are provided with necessary means to sustain local communication there between. This implies that each sub-chassis and its associated charger ports are provided with a battery. However, the battery or like sized sub-assembly parts should not be placed across the central slot in between the two sub-chassis, nor across any of the other slots in the first or second plate conductors, which form a part of a resonant structure.

The antennas described in the various disclosed embodiments further permit wireless electronics components to be integrated within the antenna structure. Integration is made possible by making the solid sections in the plates “hollow” to accommodate the placement of the components. The antenna described above can also be incorporated into an infrastructure supporting the wireless communications device, like a base transceiver station (BTS). When incorporated into the BTS, the antenna eliminates the need for multiple antennas as the antenna by itself is capable to resonate in multiple frequency bands. The antenna is self balanced and does not cause any common mode excitation to its feeding transmission line. Hence, the antenna does not require a balun (balancer-un-balancer). Further, the second frequency response of the antenna can be trimmed independent of the first frequency response.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

1. An antenna comprising:
first and second plate conductors, which are substantially symmetric, dimensions of each plate conductor including a respective length and width, where the first and second plate conductors are separated by a central slot having a predetermined width, each of the first and second plate conductors includes a respective primary feed point proximate the central slot, which together are adapted for receiving a differential signal; and
wherein the first and second plate conductors are adapted for radiating one or more signals at two or more frequencies, where the two or more frequencies are dependent upon one or more of the dimensions of the first and second plate conductors in relation to the respective feed point.

2. An antenna in accordance with claim 1, wherein each plate conductor has a pair of edges, which is separated by the width of the respective plate conductor, and wherein the respective primary feed point is proximate one of the edges.

3. An antenna in accordance with claim 2, wherein the respective primary feed point is positioned an offset distance away from the proximate edge.

4. An antenna in accordance with claim 1, wherein a first frequency of the two or more frequencies is dependent upon a diagonal length of the respective plate conductor from the primary feed point to a corner of the plate conductor located substantially opposite the feed point.

5. An antenna in accordance with claim 4, wherein the diagonal length of the respective conductor from the primary feed point to a corner of the plate conductor located substantially opposite the feed point is approximately one quarter of the wavelength of the first frequency.

6. An antenna in accordance with claim 1, wherein a second frequency of the two or more frequencies is dependent upon an effective width of the respective plate conductor from the primary feed point to an opposite edge of the plate conductor proximate the central slot.

7. An antenna in accordance with claim 6, wherein the effective width of the respective plate conductor from the primary feed point to an opposite edge of the plate conductor proximate the central slot is approximately one quarter of the wavelength of the second frequency.

8. An antenna in accordance with claim 6, further comprising a notch, at the opposite edge of the plate conductor and extending in from the edge of the plate conductor, proximate the central slot, a distance corresponding to a depth of the notch, wherein the effective width of the respective plate conductor is dependant upon the distance between the primary feed point and the opposite edge, less the depth of the notch.

9. An antenna in accordance with claim 8, wherein the notch has a width, which extends from the central slot and along the length of the respective plate conductor a distance, which is substantially equal to or greater than the predetermined width of the central slot.

10. An antenna in accordance with claim 1, wherein one or more of the respective plate conductors includes a secondary slot, which extends from a distal one of a pair of edges defined by the length of the plate conductor, which is distal relative to the central slot, and extends along a path toward a center of the respective conductor along the length of the plate conductor, and wherein the secondary slot includes a respective secondary feed point proximate the end of the secondary slot toward the center of the respective plate conductor, and wherein the respective plate conductor is adapted to radiate at a third frequency, where the third frequency is dependent upon the length of the path of the secondary slot relative to the secondary feed point.

11. An antenna in accordance with claim 10, wherein along the length of one or more of the one or more secondary slots, the length of the path of the slot includes one or more changes in direction.

12. An antenna in accordance with claim 10, wherein the length of the path of the secondary slot relative to the secondary feed point is approximately one quarter of the wavelength of the third frequency.

13. An antenna in accordance with claim 1, wherein the antenna is incorporated in a wireless communication device.

14. An antenna in accordance with claim 1, wherein the antenna is incorporated in a base transceiver station forming part of an infrastructure of a wireless communication system.

15. A wireless communication device comprising:
an antenna, the antenna comprising:
first and second plate conductors, which are substantially symmetric, dimensions of each plate conductor including a respective length and width, where the first and second plate conductors are separated by a central slot having a predetermined width, each of the first and second plate conductors includes a respective primary feed point proximate the central slot, which together are adapted for receiving a differential signal; and
wherein the first and second plate conductors are adapted for radiating one or more signals at two or more frequencies, where the two or more frequencies are dependent upon one or more of the dimensions of the first and second plate conductors in relation to the respective feed point; and
at least one of a primary transmitter and a primary receiver coupled to the respective primary feed points.

16. A wireless communication device in accordance with claim 15, wherein one or more of the respective plate conductors includes a secondary slot, which extends from a distal one of a pair of edges defined by the length of the plate conductor, which is distal relative to the central slot, and extends along a path toward a center of the respective plate conductor along the length of the plate conductor, and wherein the secondary slot includes a respective secondary feed point proximate the end of the secondary slot toward the center of the respective plate conductor, and wherein the respective plate conductor is adapted to radiate at a third frequency, where the third frequency is dependent upon the length of the path of the secondary slot relative to the secondary feed point, and wherein the wireless communication device further comprises at least one of a respective secondary transmitter and a respective secondary receiver coupled to each of the respective secondary feed points.

17. A wireless communication device in accordance with claim 15, further comprising a two part housing including a upper housing and a lower housing, and wherein the first plate conductor is incorporated as part of the upper housing and the second plate conductor is incorporated as part of the lower housing.

18. A wireless communication device in accordance with claim 17, wherein the first and second plate conductor are incorporated as part of a chassis of the respective upper and lower housings.

19. A wireless communication device in accordance with claim 18, wherein the chassis includes a printed circuit board.

20. A wireless communication device in accordance with claim 17, wherein the upper and lower housing rotate relative to one another, about a hinge.
